(19) United States
(12) Patent Application Publication
(10) Pub. No.: US 2025/0065766 A1
(43) Pub. Date: Feb. 27, 2025

(54) Head Assembly for Connecting a Plurality of Spatially Separate Charging Modules, Charging Module and Charging System

(71) Applicant: Siemens Aktiengesellschaft, München (DE)

(72) Inventor: Sebastian Bode, Ahlen (DE)

(73) Assignee: Siemens Aktiengesellschaft, München (DE)

(21) Appl. No.: 18/812,339

(22) Filed: Aug. 22, 2024

(30) Foreign Application Priority Data
Aug. 25, 2023 (DE) 10 2023 208 172.5

(51) Int. Cl. B60L 53/67; B60L 53/30; B60L 53/62

(52) U.S. Cl. CPC B60L 53/67; B60L 53/30; B60L 53/62

(57) ABSTRACT

Various embodiments of the teachings herein include charging modules for electrically charging an energy storage unit of an at least partially electrically driven transport machine. An example charging module includes: an electrical operating connection comprising two conductors to supply current to the charging module through the head assembly; an electrical charging connection comprising two conductors to electrically charge the energy storage unit using the charging module; an electrical interface comprising two conductors to transmit control signals; and a measuring device to measure an electrical variable and transmit a value of the measured electrical variable to the head assembly.

### CROSS-REFERENCE TO RELATED APPLICATIONS

This application claims priority to DE Application No. 10 2023 208 172.5 filed Aug. 25, 2023, the contents of which are hereby incorporated by reference in their entirety.

### TECHNICAL FIELD

The present disclosure relates to charging modules. Various embodiments of the teachings herein include head assemblies for connecting a plurality of spatially separate charging modules, charging modules, and charging systems.

### BACKGROUND

The term “plaza charging” designates a charging infrastructure that enables electrical charging of a relatively large number of electric vehicles, wherein neither the duration of the charging nor individual recording of the respective charging energy is critical on account of a relatively long or indefinite dwell time of the electric vehicles. Such plaza charging is used, for example, in fleets where electric vehicles parked there are electrically charged during their parked time and the charging energy required for this does not have to be billed separately. Electric charging may also be managed and offered as an additional service in other large car parks or parking garages, wherein the charging energy is provided, for instance, free of charge, or alternatively provided on a flat-rate or a time-dependent basis, for instance in conjunction with a fee for the parked time.

Equipping entire parking garages and other large parking areas with charging infrastructure is one of the more economically complex projects within the field of electromobility. Admittedly, the need for such equipment with regard to sector coupling and control of charging processes that is beneficial to the grid is fully recognized. However, economic incentives to implement this charging infrastructure are rather low, since utilization will usually be expected to be low due to high downtimes relative to the charged energy.

### SUMMARY

The teachings of the present disclosure may be used for a charging infrastructure for a plurality of charging points, for which the technical complexity for a single charging point is as low as possible. For example, some embodiments include a charging module for electrically charging an energy storage unit of an at least partially electrically driven transport machine, wherein the charging module is provided for the spatially separate connection at a head assembly connected to an energy supply network, the charging module comprising; an electrical operating connection, comprising at least two conductors, for supplying current to the charging module by way of the head assembly; an electrical charging connection, comprising at least two conductors, for electrically charging the energy storage unit by way of the charging module; an electrical interface, comprising at least two conductors, for transmitting control signals; and a measuring device for measuring at least one electrical variable and for transmitting a value of the measured electrical variable to the head assembly.

In some embodiments, the measuring device is configured in such a way that the at least one electrical variable is measured at the instruction of the head assembly.

In some embodiments, the measuring device is configured in such a way that the at least one electrical variable is measured selectively.

In some embodiments, the charging module includes a matching resistor and/or other apparatuses for influencing the level and/or signal of data lines carried via the charging connection.

In some embodiments, the charging module includes apparatuses for mounting and locking the charging module onto a supporting rail.

As another example, some embodiments include a head assembly for connecting a plurality of spatially separate charging modules by way of an electrical connection comprising at least two conductors, the head assembly comprising: a recording unit, by means of which a value, which is transmitted by at least one charging module, of an electrical variable measured there is able to be received in order to record an electrical energy exchanged by at least one charging module; and a control unit, by means of which an electrical power supplied to operate all the charging modules is able to be controlled.

As another example, some embodiments include a charging system, comprising at least one charging head station as described herein and a plurality of charging modules as described herein.

In some embodiments, the charging modules are substantially of the same design, or identical, to one another.

### BRIEF DESCRIPTION OF THE DRAWINGS

Further exemplary embodiments and advantages of the teachings herein are explained in more detail below with reference to the drawing, in which:

FIG. 1 shows a schematic structural illustration of a measurement of an electrical variable at an operating connection of an example charging module incorporating teachings of the present disclosure;

FIG. 2 shows a schematic structural illustration of a measurement of an electrical variable at a charging connection of an example charging module incorporating teachings of the present disclosure;

FIG. 3 shows a schematic structural illustration of a measurement of an electrical variable at the operating connection of an example charging module incorporating teachings of the present disclosure;

FIG. 4 shows a schematic structural illustration of a measurement of an electrical variable at the operating connection of an example charging module incorporating teachings of the present disclosure;

FIG. 5 shows a schematic cross section through a charging module incorporating teachings of the present disclosure; and

FIG. 6 shows a schematic cross section through a charging module incorporating teachings of the present disclosure.

### DETAILED DESCRIPTION

Some teachings of the present disclosure include a head assembly for connecting a plurality of spatially separate charging modules and/or a modular charging systems. A charging module may be provided at each charging point. A charging point is a location at which one or more energy storage units of exactly one at least partially electrically driven transport machine parked there are able to be charged at the same time.

The charging modules incorporating teachings of the present disclosure may be used for electrically charging an energy storage unit of an at least partially electrically driven transport machine, for example electric vehicle. Each charging module is provided for a spatially separate connection at a respective or common head assembly to which the charging points are connected according to a principle of a modular system. By way of example, such a spatially separate connection may be implemented by a series connection using busbars, in the case of which the respective operating connections of the charging modules are connected in parallel with a current source of the head assembly, such that substantially the same magnitude of a voltage is present at the operating connections of the connected charging modules. In some embodiments, an annular connection is also conceivable, in the case of which the respective operating connections of the charging modules are connected in series with a voltage source of the head assembly, such that substantially the same magnitude of an electric current intensity flows through the connected charging modules. Mixed forms with hybrid series and parallel circuits in a plurality of branches may also be formed within the framework of such a spatially separate connection.

In some embodiments, a charging module comprises an electrical operating connection for supplying current to the charging module by way of the head assembly. The operating connection comprises at least two conductors. AC current may be used for the current supply.

In some embodiments, the charging module further comprises a charging connection for electrically charging the energy storage unit of the transport machine. The charging connection comprises a charging cable permanently attached to the charging module, a charging socket for inserting a charging cable or else devices for inductively charging or discharging the at least partially electrically driven transport machine. The electrical charging connection comprises at least two conductors. Transport machines at least partially driven using electrical energy that are used nowadays are usually able to convert AC current into DC current required for charging the battery and to provide a magnitude of a DC voltage that is dependent on a type of the energy storage unit and its state of charge.

In some embodiments, the charging module further comprises an electrical interface, comprising at least two conductors, for transmitting control signals or measured values. Although nowadays an implementation of digital interfaces may be given preference, this electrical interface for transmitting control signals or measured values may also be in analog form in order to keep the technical complexity for a single charging point as low as possible. In this case, the electrical interface may also be in the form of a flat ribbon cable, which may be suitable for actuating contactors.

When measuring an electrical variable and transmitting a value of a measured electrical variable, for example, current intensity, voltage, electrical power, etc., to the head assembly, as described hereinafter, this value may also be transmitted via an analog interface, for example, by transmitting the value by way of an appropriately set electric current by means of an appropriate interconnection of an operational amplifier, or by way of a voltage by means of a voltage follower circuit. In particular, the latter may improve the synchronization of individual measurements.

In some embodiments, the electrical interface for transmitting control signals or measured values may also be in digital form by virtue of the measured value being measured and output in a digital manner, or measured in an analog manner and digitized in a conventional manner, e.g. by means of an analog-to-digital converter. Instead of a fully digitized design via an Ethernet interface, the electrical interface for transmitting control signals or measured values may also have a simpler design by virtue of control commands or measured values being transmitted via bus telegrams.

Finally, the charging module comprises a measuring device for measuring at least one electrical variable and for transmitting a value of the measured electrical variable to the head assembly.

In order to make the charging infrastructure as inexpensive as possible for a plurality of charging points, the teachings of the present disclosure may keep a technical complexity for the majority of charging modules as low as possible and of instead transferring this technical complexity to the head assembly that is, for example, provided only once, or at least only in small numbers, within the charging infrastructure.

Further control functions of a conventional charging station, which are not shown in detail in this description—may also be assigned to this head assembly so as to keep the technical complexity in the charging modules low. By way of example, these control functions include a specification of a power limit value or current limit value, an ascertainment of an output or received electrical energy from received or self-ascertained measured values, a calculation of the electrical energy, or a connection to corresponding systems.

In some embodiments, the measuring device is configured in such a way that the at least one electrical variable is measured at the instruction of the head assembly. This configuration supports the effort to keep the technical complexity in the charging modules as low as possible and to instead transfer technical complexity to the head assembly. Continuous measurement of electrical variables in the individual charging modules is not necessary to determine the electrical energy used for charging purposes in the entire charging infrastructure. This is therefore carried out in an manner which saves on energy and data at the instruction of the head assembly.

In some embodiments, the measuring device thereof is configured in such a way that the at least one electrical variable is measured selectively. “Selectively” means that measurements of the at least one electrical variable are not carried out by all the charging modules, but rather only by individual charging modules, or even by no charging module, within a considered period of time. The last variant is especially a possibility if an electrical variable is intended to be measured only at the instruction of the head assembly, for example for monitoring purposes. This configuration also supports the effort to keep the technical complexity in the charging modules as low as possible and to instead transfer technical complexity to the head assembly. Simultaneous measurement of electrical variables in the individual charging modules is not necessary to determine the electrical energy used for charging purposes in the entire charging infrastructure. This is therefore carried out in a manner which saves on energy and data at the instruction of the head assembly.

In some embodiments, said charging module comprises at least one matching resistor and/or other apparatuses for influencing the level and/or signal of data lines carried via the charging connection. By way of example, the charging modules have at least one matching resistor, which may be used to generate a CP signal according to IEC63851 from a raw CP signal. In some embodiments, other apparatuses for influencing the level and/or signal that are in the form of more complex circuits are also conceivable, which not only match the impedance, but also the level and/or improve the edge steepness.

Against the background that, within the framework of the charging infrastructure incorporating teachings of the present disclosure, that is to say the charging systems described herein, a plurality of transport machines or electric vehicles are connected to the plurality of charging modules, the CP signal ensures a distinction between the electric vehicles. The CP signal is used to transmit states by way of its voltage level. A setpoint current intensity according to IEC63851 is transmitted via a pulse-width-modulated or step-modulated signal. The raw CP signal provides, inter alia, essential information regarding the level of a maximum current consumption of an individual electric vehicle. During AC charging, a current consumption of the electric vehicle is controlled by the electric vehicle, which may also connect-in additional resistors.

In some embodiments, said charging module comprises apparatuses for mounting and locking the charging module onto a supporting rail or top-hat rail. There is a receptacle on the rear side of the charging module for this purpose. This measure may significantly reduce the technical complexity for the installation and the required installation space for the charging module.

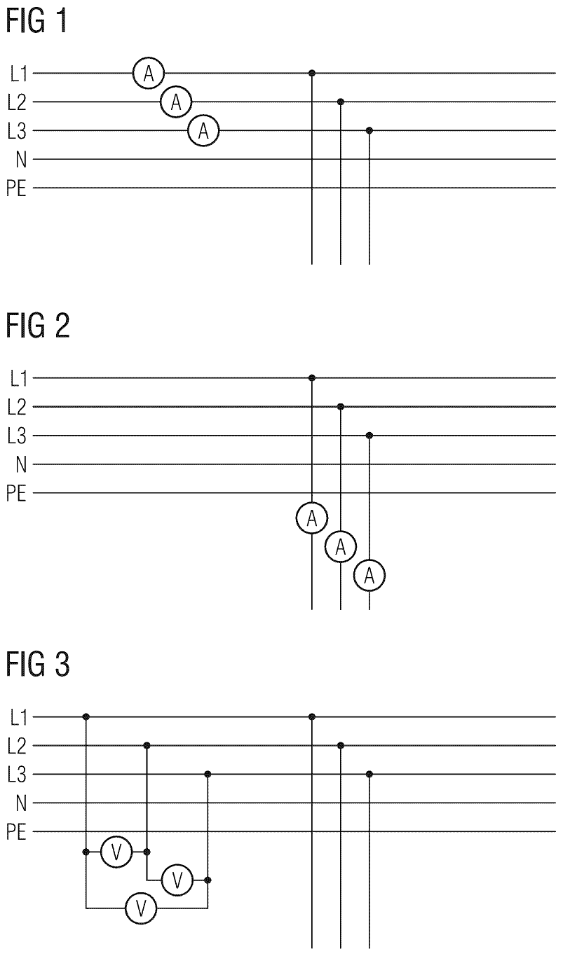

In FIG. 1 to FIG. 4, conductors L1, L2, L3, N, PE, which run horizontally above one another, show an electrical operating connection, which in this case comprises five conductors, for supplying AC current to a plurality of charging modules, which are not shown, by way of a head assembly, which is not shown.

The conductors shown comprise three outer conductors L1, L2, L3, a neutral conductor N and a protective conductor PE for supplying AC current or three-phase current to the charging module. Within the charging module, which is not shown, as shown in the drawings, for example, the three outer conductors L1, L2, L3 of the operating connection are each connected to one of three conductors, which run downward, of an electrical charging connection. The charging connection is electrically connected to a socket, which is not shown, or a charging cable, which is not shown, for electrically charging the transport machine. An installation for the respective branching of the three outer conductors L1, L2, L3 of the operating connection to the respective conductor, which runs downward, for the electrical charging connection is located in a housing of the charging module, which is not shown for reasons of clarity.

In some embodiments, in which a respective outer conductor L1, L2, L3 of the operating connection is branched to one of three conductors of the charging connection, a single-phase branching may also be selected, in which, for example, in the context of an alternate safety installation, a second outer conductor L2 is branched to the neutral conductor N at a first charging module, and a third outer conductor L2 is branched to the neutral conductor N at a subsequent charging module. The five conductors L1, L2, L3, N, PE of the operating connection are designed, for example, as a respective busbar, ribbon cable or other type of installation suitable for a multiple connection. Further possible control lines, signal lines and/or data lines, which are optionally carried with the conductors L1, L2, L3, N, PE of the operating connection, for transmitting measured values and/or control signals are not shown in the drawings for reasons of clarity. For the same reason, further possible signal lines or data lines, which are optionally carried with the conductors of the charging connection, are not shown in the drawings.

FIG. 1 shows a three-phase electric current measurement by way of the charging module, which is carried out at the operating connection for supplying AC current to the charging module by way of the head assembly. The current measurement is carried out by a respective current measuring device A, which is interconnected in a circuit of a respective outer conductor L1, L2, L3. In addition to the current measurement shown, any other or extended measuring devices are able to be used to measure at least one electrical variable.

FIG. 2 shows a three-phase electric current measurement at a three-phase charging connection for charging an energy storage unit, which is not shown, connected to the charging module, which is not shown. The three-phase charging connection with three electrical conductors leads downward in the drawing. The current measurement, that is to say the measurement of the charging current, is carried out by a respective ammeter A, which is interconnected in a circuit of a respective conductor. In addition to the current measurement shown, any other or extended measuring devices are able to be used to measure at least one electrical variable.

FIG. 3 shows a three-phase voltage measurement by way of the charging module, which is carried out at the operating connection for supplying AC current to the charging module by way of the head assembly. The voltage measurement is carried out by a respective voltmeter V, wherein a respective voltmeter V is arranged between a respective outer conductor L1 and a subsequent outer conductor L2. In addition to the voltage measurement shown, any other or extended measuring devices are able to be used to measure at least one electrical variable.

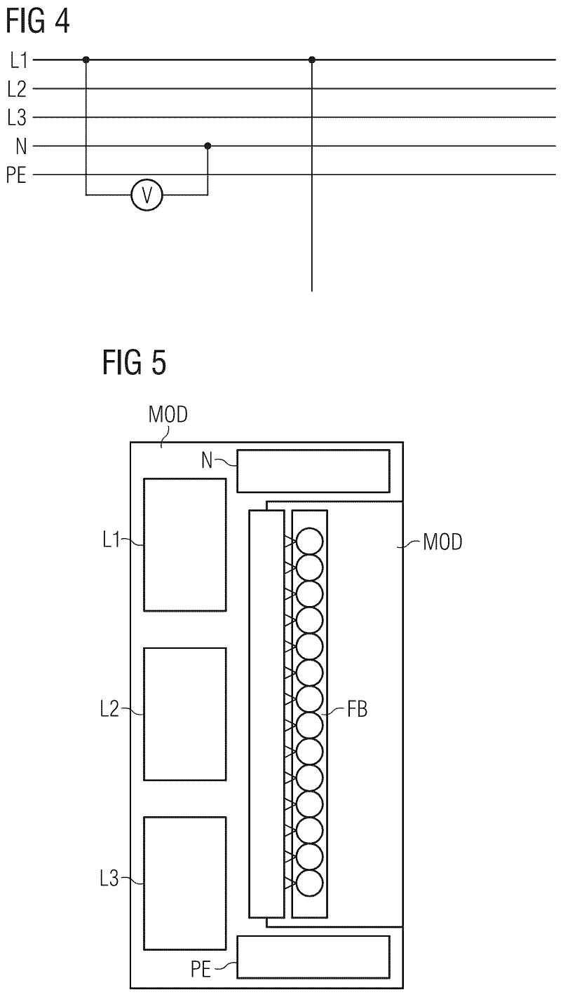

FIG. 4 shows a single-phase voltage measurement by way of the charging module, which is carried out at the operating connection for supplying AC current to the charging module by way of the head assembly. The voltage measurement is carried out by a voltmeter V, which measures a voltage between a first outer conductor L1 and the neutral conductor N.

FIG. 5 shows a schematic cross section through a charging module MOD incorporating teachings of the present disclosure. The charging module MOD has an operating connection for establishing a connection with the five conductors L1, L2, L3, N, PE. Furthermore, the charging module MOD has a charging connection, which is not shown, for electrically charging the energy storage units.

Some embodiments include a contact to a flat ribbon cable FB, which forms an electrical interface comprising a plurality of, at least two, conductors with a self-contacting design for transmitting control signals with the head assembly. Although an implementation of a digital interface is also possible within the scope of the invention, this interface may also be designed with a flat ribbon cable for partially analog transmission of control signals or measured values in order to keep the technical complexity for an individual charging module MOD as low as possible according to the stated object of the invention. Using analog signals in particular makes it possible to identify cable breaks, that is to say interruptions in the electrical connections, e.g. as a result of mechanical damage or wear, due to a failure of the analog signal, and to react to this in a suitable manner.

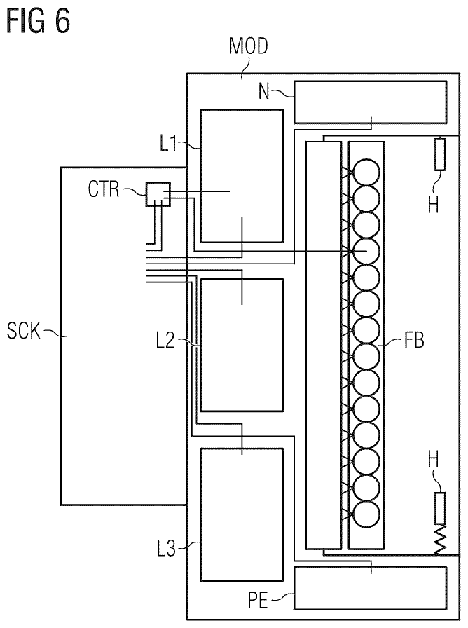

FIG. 6 shows a schematic cross section through an example charging module MOD incorporating teachings of the present disclosure. The figures are further described with further reference to the functional units of FIG. 5. Identical reference signs in both figures in this case represent identical functional units. In comparison to the embodiment shown in FIG. 5, the embodiment shown in FIG. 6 has, on the one hand, an illustration that is more detailed in parts, for example internal current supply lines and data lines are shown without reference signs, and on the other hand, further assemblies with more specific configurations are shown in comparison to the overview drawing of FIG. 5.

In this embodiment, the charging module MOD has a plug socket SCK as a possible design of the charging connection for electrically charging the energy storage unit, which is not shown, of the transport machine, which is not shown. This can be, for example, a plug socket SCK connected to the charging module MOD, as shown, or else a plug socket SCK spatially separate from the charging module MOD. By way of example, the plug socket is designed according to IEC 61851.

Furthermore, the charging module MOD has a control unit CTR, which, as shown, is connected to at least one of the in this case five conductors L1, L2, L3, N, PE of the operating connection for measuring at least one electrical variable. The control unit CTR may also be configured to transmit one or more values of this measured electrical variable to the head assembly.

Furthermore, the charging module MOD has a device for mounting and locking the charging module onto a supporting rail or top-hat rail. In the example in the drawing, the device comprises two latching lugs that are able to be locked by spring force and that engage into a support element, which is not shown, of a bracket or supporting rail.

Some embodiments of the teachings herein include a modular charging system with a head assembly for connecting a plurality of spatially separate charging modules. A charging module incorporating teachings of the present disclosure include a measuring device for measuring at least one electrical variable and for transmitting a value of the measured electrical variable to the head assembly. The charging module is designed with low technical complexity so as to instead transfer this technical complexity to the head assembly that is, for example, provided only once, or at least only in small numbers, within the charging infrastructure.

For charging systems with a plurality of charging points equipped with charging modules, for which the technical complexity for an individual charging point is to be kept as low as possible, the modular charging system contributes to a considerable reduction in this required technical complexity, both in financial terms and with regard to the required installation space. At the same time, regardless of the reduction in the required technical complexity, a consistently high measurement reliability compared to conventional charging points is maintained, which is able to be used at least for checking the plausibility of values determined or measured by the vehicle, that is to say as part of a cost-saving intermittent or case-by-case collection of measured values, for example for a random comparison of a measurement, which is selectively prompted at a charging module, of at least one electrical variable.

1. A charging module for electrically charging an energy storage unit of an at least partially electrically driven transport machine, wherein the charging module operates to provide multiple spatially separate connections at a head assembly connected to an energy supply network, the charging module comprising:
an electrical operating connection comprising two conductors to supply current to the charging module through the head assembly;
an electrical charging connection comprising two conductors to electrically charge the energy storage unit using the charging module;
an electrical interface comprising two conductors to transmit control signals; and
a measuring device to measure an electrical variable and transmit a value of the measured electrical variable to the head assembly.

2. The charging module as claimed in claim 1, wherein the measuring device measures the electrical variable in response to an instruction of the head assembly.

3. The charging module as claimed in claim 1, wherein the measuring device measures the electrical variable selectively.

4. The charging module as claimed in claim 1, further comprising a matching resistor to influence a level and/or a signal of data lines carried via the charging connection.

5. The charging module as claimed in claim 1, further comprising apparatuses to mount and lock the charging module onto a supporting rail.

6. A head assembly for connecting a plurality of spatially separate charging modules by way of an electrical connection comprising two conductors, the head assembly comprising:
a recording unit to receive a value of an electrical variable measured and transmitted by a charging module and record an electrical energy exchanged by the charging module; and
a control unit to control supply of electrical power to operate all the charging modules.

7. A charging system comprising:
a head assembly for connecting a plurality of spatially separate charging modules by way of an electrical connection comprising two conductors, the head assembly comprising:
a recording unit to receive a value of an electrical variable measured and transmitted by a charging module and record an electrical energy exchanged by the charging module; and
a control unit to control supply of electrical power to operate all the charging modules;
a plurality of charging modules for electrically charging an energy storage unit of an electrically driven transport machine, wherein the charging module is provided for the spatially separate connection at a head assembly connected to an energy supply network, each charging module comprising:
an electrical operating connection comprising two conductors to supply current to the charging module through the head assembly;
an electrical charging connection comprising two conductors to electrically charge the energy storage unit using the charging module;
an electrical interface comprising two conductors to transmit control signals; and
a measuring device to measure an electrical variable and transmit a value of the measured electrical variable to the head assembly.

8. The charging system as claimed in patent claim 7, wherein the plurality of charging modules are substantially of the same design as one another.
